(19) United States
(12) Patent Application Publication
(10) Pub. No.: US 2025/0326919 A1
(43) Pub. Date: Oct. 23, 2025

(54) COLLATION SHRINK FILM

(71) Applicant: Dow Global Technologies LLC, Midland, MI (US)

(72) Inventors: Yongchao Zeng, Houston, TX (US); Weiming Ma, Shanghai (CN); Jichang Feng, Shanghai (CN); Shenglong Chen, Shanghai (CN); Amit K. Chaudhary, Missouri City, TX (US); Christopher M. Thurber, Midland, MI (US)

(21) Appl. No.: 18/851,732

(22) PCT Filed: Jun. 16, 2022
(86) PCT No.: PCT/CN2022/099278

§ 371 Date: Sep. 27, 2024

(51) Int. Cl. C08L 23/06; B65B 11/00; B65B 53/02; B65D 75/00; C08J 5/18

(52) U.S. Cl. CPC C08L 23/06; B65B 11/004; B65B 53/02; B65D 75/002; C08J 5/18; C08J 2323/06; C08J 2423/06; C08L 2203/162; C08L 2205/025; C08L 2205/03; C08L 2207/062; C08L 2207/066; C08L 2207/20

(57) ABSTRACT

A shrink film including: at least one monolayer or multi-layer film having at least one layer comprising a formulated resin, wherein the formulated resin includes: (a) at least one post-consumer recycled resin sourced from recycled high density polyethylene resin having a density of from 0.940 g/cc to 0.970 g/cc, and a melt index, I₂, of from 0.01 g/10 min to 1.0 g/10 min; (b) at least one post-consumer recycled resin sourced from recycled low density polyethylene resin having a density of from 0.915 g/cc to 0.935 g/cc, and a melt index, I₂, of from 0.1 g/10 min to 1.0 g/10 min; and (c) at least one virgin low density polyethlene resin having a density of from 0.915 g/cc to 0.925 g/cc and a melt index, I₂, of from 0.1 g/10 min to 2 g/10 min.

### FIELD

The present invention relates to packaging film; and more specifically, the present invention relates to collation shrink films made from polymer blend compositions including recycled plastic or post-consumer recycled (PCR) resin materials and the preparation of such collation shrink films.

### BACKGROUND

Using recycled materials is thought to be better for the environment and decreases the waste of natural resources that are used for disposable products. Therefore, the more recycled materials that can be used would be better for the environment. However, it is generally recognized in the art that products made from recycled materials often have physical properties which are generally less acceptable than products made from virgin materials. As a result, the use of recycled materials in products is often limited due to the loss in physical properties of products prepared from recycled materials. For example, PCR resin materials have inferior properties when compared to virgin polyethylene (PE) due to contamination and excessive thermal history associated with the recycling process of PCR resin materials, thereby limiting the maximum loading of PCR resin materials that can be achieved when blending the PCR resin materials with other resins. It is also a challenge to upcycle the PCR resin material into high end clear film applications; and it is difficult to incorporate a meaningful and proper amount of PCR resin material into a blend formulation to be used to manufacture an end-use product.

An example of an end-use where PCR resin material is desired includes a collation shrink film (CSF) packaging application. Collation shrink films and methods of making collation shrink films are known. However, the use of PCR resin materials for manufacturing collation shrink films is limited due to: (1) the lack of homogeneity of the PCR resin material; (2) the high contamination of the PCR resin material, and (3) the defects in films (e.g., undesirable gel formation; reduction in processability; and degradation in the mechanical properties of the film) that the use of PCR resin material creates. Therefore, there is a need to find a solution to the above limitations when using recycled products to produce films or other articles without impacting the quality of the films or articles made from the films. In particular, it is desirous to produce collation shrink films containing meaningful amounts of PCR resin material, wherein the films containing PCR resin material have a combination of good aesthetics (e.g., reduced defect count), toughness (e.g., puncture resistance, dart drop impact, and tear strength), stiffness (e.g., secant modulus), shrink force, contraction force, shrinkage, and processability. The above film properties are known to be improved individually. However, currently available film structures utilizing PCR resin material do not combine all of the above properties satisfactorily in a film having a sufficiently thin gauge to be commercially attractive.

### SUMMARY

One general embodiment of the present invention is directed to a compounded multi-component melt blend composition or formulation (also referred to herein as “formulated resin”) including two or more PCR resin materials in combination with one or more virgin polymer resin materials; wherein the formulated resin can be compounded into a one-pellet form material. Then the one-pellet form material can be used for producing a collation shrink film (CSF) and the resulting CSF can be used in packaging applications.

For example, in one preferred embodiment, the melt blend formulation for forming a shrink film therefrom includes:
(a) at least one post-consumer recycled resin sourced from recycled high density polyethylene resin having a density of from 0.940 g/cc to 0.970 g/cc, and a melt index, I₂, of from 0.01 g/10 min to 1.0 g/10 min;
(b) at least one post-consumer recycled resin sourced from recycled low density polyethylene resin having a density of from 0.915 g/cc to 0.935 g/cc, and a melt index, I₂, of from 0.1 g/10 min to 2.0 g/10 min;
(c) at least one virgin low density polyethylene resin having a density of from 0.915 g/cc to 0.925 g/cc and a melt index, I₂, of from 0.1 g/10 min to 1 g/10 min; and
(d) optionally, at least one additive different from components (a), (b) and (c), if desired.
wherein the post-consumer recycled resin loading of the formulated resin from ≥30 percent to 90 percent.

In another general embodiment, the present invention is directed to a pellet article made from the above compounded multi-component melt blend formulation.

In still another general embodiment, the present invention is directed to a film article (e.g., a CSF) made from the above pellet article. For example, it has been discovered that CSF products made from a polymer blend formulation of the present invention comprising two or more PCR resin materials as discussed and described herein can have improved properties. In one embodiment, the present invention is directed to a multi-layer CSF structure, wherein at least one layer of the CSF structure includes a layer made from the above-described formulated resin and pellet article. In a preferred embodiment, the multi-layer CSF film structure can be at least a three-layer structure including a core layer and two skin layers, wherein the skin layers include high optics skin layers, and wherein the core layer comprises the above-described formulated resin and pellet article.

In other general embodiments, the present invention is directed to processes for preparing the above compounded multi-component melt blend formulation, the pellet article, and the CSF product.

One objective of the present invention is to provide a compounded multi-component melt blend formulation which includes two or more PCR resin materials in combination with virgin polymer materials; and which can be compounded into a one-pellet form material. By blending together two or more appropriate PCR resin materials of different grades with one or more virgin polymer materials, the overall PCR resin material loading level of the blend formulation can be enhanced while maintaining the mechanical, thermal, and optical properties of the enduse product made from the compounded multi-component melt blend formulation. In addition, the processability of the one-pellet form material can be enhanced; and the shrink force of a CSF can be increased for use in CSF applications. And, by incorporating a filtration step into the compounding process, the process can produce a one-pellet compounded product which readily can be processed into a film product with exceptionally low gels and high aesthetics.

Another objective of the present invention is to provide a formulated resin used for producing a CSF; wherein the formulated resin used in the CSF includes two or more PCR resin materials in combination with one or more virgin polymer materials; and wherein one PCR resin material (e.g., of the two or more PCR resin materials) is sourced from recycled high density polyethylene resin obtained from blow-molded bottles (e.g., milk bottles, beverage bottles, sauce bottles, and the like) whereas the other PCR resin material (e.g., of the two or more PCR resin materials) is sourced from recycled flexible films made of polyethylene (e.g., shrink films, logistic films, stretch film, and the like).

Another objective of the present invention is to provide a CSF that: (1) is prepared from the above-described formulated resin which has an increased load level percentage of PCR resin material; (2) has a low number of defects; (3) exhibits good mechanical properties; and (4) exhibits good shrink force properties.

### BRIEF DESCRIPTION OF THE DRAWINGS

FIG. 1 is a graphical illustration showing melt strength of various sample pellets prepared in the Examples.

### DETAILED DESCRIPTION

Reference will now be made in detail to embodiments of the formulated resin, the pellet article, and the film containing PCR material. The formulated resin, the pellet article, and the film may be used in collation shrink film applications; however, it is noted that these items are merely exemplary of illustrative implementations of the embodiments disclosed herein. The embodiments are applicable to other resin, pellet, film, or molded item technologies that desire incorporation of PCR resin material; having a low number of defects; exhibiting good mechanical properties; and exhibiting good shrink properties.

The term “composition” refers to a mixture of materials that comprises the composition, as well as reaction products and decomposition products formed from the materials of the composition.

As used herein, the term “polymer” refers to a polymeric compound prepared by polymerizing monomers, whether of the same or a different type. The generic term “polymer” thus embraces: (1) the term homopolymer (employed to refer to polymers prepared by polymerizing only one type of monomer, with the understanding that trace amounts of impurities can be incorporated into the polymer structure); and (2) the term copolymer or interpolymer (employed to refer to polymers prepared by polymerizing two or more different monomers, with the understanding that trace amounts of impurities can be incorporated into the polymer structure). Trace amounts of impurities (for example, catalyst residues, chain transfer agent, branching agent, peroxide residues, and the like) may be incorporated into and/or within the polymer. A polymer may be a single polymer or a polymer blend.

The term “interpolymer” refers to polymers prepared by polymerizing at least two different types of monomers. The generic term interpolymer thus includes copolymers and other polymers prepared by polymerizing more than two different monomers, such as terpolymers.

“Virgin polymer”, “virgin material”, “virgin raw polymer”, “virgin raw material”, “virgin resin”, “primary polymer”, and “primary raw material”, among other terms, refer to polymers that can be characterized as “primary (virgin) raw material,” as defined by ISO 18604. The generic term virgin with reference to a polymer or raw material thus includes polymers or materials, as originally sourced, that have never been processed into any form of end-use product. In other words, the virgin polymers or materials are pure, unmodified, unmixed, and unadulterated, i.e., the original virgin materials have not been mixed or adulterated with any other substance or material. The virgin polymers are discussed further herein.

A “blend formulation” and “formulated resin” of the present invention includes a “virgin polyethylene resin”, that is, a virgin polymeric material as described above and includes one or a blend of multiple polyethylene compositions. This blend of multiple polyethylene compositions may include a multimodal in-reactor blend or a physical blend of multiple polyethylenes melt blended, dry blended, and the like.

The terms “pre-consumer recycled polymer” and “post-industrial recycled polymer” refer to polymers, including blends of polymers, recovered from pre-consumer material, as defined by ISO 14021. The generic term pre-consumer recycled polymer thus includes blends of polymers recovered from materials diverted from the waste stream during a manufacturing process. The generic term pre-consumer recycled polymer excludes the reutilization of materials, such as rework, regrind, or scrap, generated in a process and capable of being reclaimed within the same process that generated it.

The term “post-consumer recycled (or “PCR”) polymer”, as used herein, refers to a polymeric material that includes materials previously used in a consumer or industry application, i.e., pre-consumer recycled polymer and post-industrial recycled polymer. PCR resin material is typically collected from recycling programs and recycling plants. The PCR resin material may include one or more of a polyethylene, a polypropylene, a polyester, a poly(vinyl chloride), a polystyrene, an acrylonitrile butadiene styrene, a polyamide, an ethylene vinyl alcohol, an ethylene vinyl acetate, or a poly-vinyl chloride. The PCR resin material may include one or more contaminants. The contaminants may be the result of the polymeric material's use prior to being repurposed for reuse. For example, contaminants may include paper, ink, food residue, or other recycled materials in addition to the polymer, which may result from the recycling process. PCR resin material is distinct from virgin polymeric material. A virgin polymeric material (such as a virgin bimodal polyethylene resin) does not include materials previously used in a consumer or industry application. Virgin polymeric material has not undergone, or otherwise has not been subject to, a heat process or a molding process, after the initial polymer manufacturing process. The physical, chemical, and flow properties of PCR resin materials differ when compared to virgin polymeric resin, which in turn can present challenges to incorporating PCR resin material into formulations for commercial use.

A “PCR polymer”, “PCR resin”, “PCR material”, or “PCR resin material” is also used herein as defined by ISO 14021:2016. The above terms refer to polymers or materials, including blends of polymers or materials, recovered from post-consumer material, as defined by ISO 14021. The generic term PCR polymer, resin or material thus includes blends of polymers/materials recovered from materials generated by households or by commercial, industrial and institutional facilities in such facilities' role as end-users of the product, which can no longer be used for the product's intended purpose. The generic term PCR polymer/material also includes blends of polymers/materials recovered from returns of materials from the distribution chain. Some of the property characteristics of a PCR polymer/material typically include, for example, a melt index in the range of from 0.01 g/10 min to 5 g/10 min; a density of from 0.910 g/cc to 0.965 g/cc; and an I₁₀/I₂ ratio of from 5 to 20. Generally, the PCR polymer/material is often a blend of various polyethylene resins.

The term “recycled polyethylene” refers to polymers, e.g., polyethylenes, recovered from post-consumer material as defined by ISO 14021, polymers recovered from pre-consumer material as defined by ISO 14021, and combinations thereof.

The term “PCR resin formulation” means a polymer “blend formulation” or a “formulated resin” as described above; and comprises at least one PCR resin, at least one ethylene/alpha-olefin copolymer, at least one virgin polymer material, at least one high density polyethylene, and optionally other components and additives. In several of the embodiments discussed herein below, the PCR resin formulation may be its own product (e.g., in a pellet form) or may be further blended with other materials to produce another product, such as a film, sheet, and the like.

The terms “polyolefin,” “polyolefin polymer,” and “polyolefin resin” refer to polymers prepared by polymerizing a simple olefin (also referred to as an alkene, which has the general formula CₙH₂ₙ) monomer. The generic term polyolefin thus includes polymers prepared by polymerizing an ethylene monomer with or without one or more comonomers, such as polyethylene, and polymers prepared by polymerizing a propylene monomer with or without one or more comonomers, such as polypropylene.

The terms “polyethylene (PE)” and “ethylene-based polymer” refer to polyolefins comprising >50 percent (%) by mole of units that have been derived from ethylene monomer, which includes polyethylene homopolymers and polyethylene copolymers (meaning units derived from two or more comonomers. Common forms of ethylene-based polymers, such as polyethylene, known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “LDPE” or “low density polyethylene” may also be referred to as “high pressure ethylene polymer” or “highly branched polyethylene”; and refers to an ethylene homopolymer prepared using a free radical, high-pressure (for example, ≥100 MPa, such as from 100 MPa to 400 MPa) polymerization. For example, the polymer is partly or entirely homopolymerized or copolymerized in autoclave or tubular reactors with the use of free-radical initiators, such as peroxides (see for example U.S. Pat. No. 4,599,392). LDPE resins typically have a density in the range of 0.916 g/cc to 0.935 g/cc.

The term “LLDPE” or “linear low density polyethylene” includes resins made using Ziegler-Natta catalyst systems as well as resin made using single-site catalysts, including, but not limited to, bis-metallocene catalysts (sometimes referred to as “m-LLDPE”), phosphinimine, and constrained geometry catalysts, and resins made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based (i.e., polyethylene) copolymers or homopolymers. LLDPEs contain less long chain branching than LDPEs and include the substantially linear ethylene polymers, which are further defined in U.S. Pat. Nos. 5,272,236; 5,278,272; 5,582,923; and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. Nos. 3,914,342 and 5,854,045). The LLDPE resins can be made via gas-phase, solution-phase, or slurry polymerization or any combination thereof, using any type of reactor or reactor configuration known in the art.

The term “MDPE” refers to polyethylenes having densities from 0.926 g/cc to 0.945 g/cc. “MDPE” is typically made using chromium or Ziegler-Natta catalysts or using single-site catalysts including, but not limited to, bis-metallocene catalysts and constrained geometry catalysts.

The term “HDPE” or “high density polyethylene” refers to ethylene-based polymers (i.e., polyethylenes) having densities >0.940 g/cc, which are generally prepared with Ziegler-Natta catalysts, chrome catalysts or single-site catalysts including, but not limited to, bis-metallocene catalysts and constrained geometry catalysts. For additional clarity, while the HDPE is an ethylene/alpha-olefin copolymer, it is not a lower density ethylene/alpha-olefin copolymer having a density of 0.850 g/cc to 0.910 g/cc as described herein.

As used herein, the terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

As used throughout this specification, the abbreviations given below have the following meanings, unless the context clearly indicates otherwise: “=” means “equal to”; “@” means “at”; “<” means “less than”; “>” means “greater than”; “≤” means “less than or equal to”; “≥” means “greater than or equal to”; “I₂” means “melt index”; g=gram(s); mg=milligram(s); pts=parts by weight; kg=kilogram(s); Kg/h=kilograms per hour; Kg/s=kilograms per second; g/cc=gram(s) per cubic centimeter; kg/m³=kilogram(s) per cubic meter; g/mol=gram(s) per mole; L=liter(s); mL=milliliter(s); g/L=gram(s) per liter; Mw=Mass molecular weight; Mn=number molecular weight; Mz=z-average molecular weight; m=meter(s); μm=micron(s); mm=millimeter(s); cm=centimeter(s); cm³=cubic centimeter(s); min=minute(s); s=second(s); mm/s²=millimeter(s) per second squared; mm/s=millimeter(s) per second; ms=millisecond(s); hr=hour(s); mm/min=millimeter(s) per minute; m/s=meter(s) per second; ° C.=degree(s) Celsius; C/min=degree(s) Celsius per minute; mPa·s=millipascals-second(s); mPa=megapascal(s); MPa=Megapascal(s); kPa=kilopascal(s); Pa·s/m²=pascals-second(s) per meter squared; N=newton(s); cN=centinewton(s); mN=millinewtons; gf=grams-force; rpm=revolution(s) per minute; mm²=millimeter(s) squared; g/10 min=gram(s) per 10 minutes; J=Joule(s); J/g=Joule(s) per gram; %=percent; eq %=equivalent percent; vol %=volume percent; and wt %=weight percent.

Unless stated otherwise, all percentages, parts, ratios, and like amounts, are defined by weight. For example, all percentages stated herein are weight percentages (wt %), unless otherwise indicated.

Temperatures are in degrees Celsius (° C.), and “ambient temperature” means between 20° C. and 25° C., unless specified otherwise.

In a broad embodiment, the present invention relates to a polymer blend formulation or composition useful for producing a film product and more specifically a collation shrink film (CSF) product. Generally, the present invention includes a formulated resin useful for preparing a film comprising, for example, a blend of: (a) at least one first post-consumer recycled resin; (b) at least one second post-consumer recycled resin; and (c) at least one virgin low density polyethylene; and (d) any optional additives different from components (a), (b) and (c), if desired.

In one preferred embodiment, the formulated resin includes:
(a) at least one first post-consumer recycled (PCR1) resin sourced from recycled high density polyethylene (r-HDPE) resin; wherein the at least one PCR1 resin has a density of from 0.940 g/cc to 0.970 g/cc, and a melt index, I₂, of from 0.01 g/10 min to 1.0 g/10 min;
(b) at least one second post-consumer recycled (PCR2) resin sourced from recycled low density polyethylene (r-LDPE) resin; wherein the at least one PCR2 resin has a density of from 0.915 g/cc to 0.935 g/cc, and a melt index, I₂, of from 0.1 g/10 min to 2.0 g/10 min; (c) at least one virgin low density polyethylene (v-LDPE) resin; wherein the at least one v-LDPE resin has a density of from 0.915 g/cc to 0.925 g/cc and a melt index, I₂, of from 0.1 g/10 min to 1 g/10 min; and
(d) any optional additives different from components (a), (b) and (c), if desired

In some embodiments, the polymer resin blend composition (i.e., r-HDPE+r-LDPE+v-LDPE resins) is advantageously used to make a CSF product. In one embodiment, the resulting CSF is a fully recyclable polyethylene structure.

Prior to making a CSF product from the polymer blend formulation, the blend formulation is first processed into pellets. For example, the materials forming the blend formulation are melt blended (mixed by melting, e.g., via an extruder) to make the melt blend formulation. Then, the melt blend formulation is passed from an extruder (e.g., a twin-screw extruder) through a strand die into a pelletizer to form the pellets of the blend formulation. Once made, the pellets are then processed to make a CSF product with the desired shrink properties.

The at least one first post-consumer recycled (PCR1) resin useful in the formulated blend formulation of the present invention, component (a), includes, for example, one or more recycled polymer resins, wherein the recycled polymer resin is selected from the group consisting of LLDPE, LDPE, HDPE, polypropylene (PP), polyamide (PA), ethylene vinyl alcohol (EVOH), polyethylene terephthalate (PET) and mixtures thereof. In a preferred embodiment, the PCR1 resin includes, for example, recycled HDPE, recycled LDPE, recycled LLDPE and mixtures thereof. In another embodiment, the at least one PCR1 resin is recycled HDPE resin, wherein the recycled HDPE resin has a density of from 0.940 g/cc to 0.970 g/cc, and a melt index, I₂, of from 0.01 g/10 min to 1.0 g/10 min.

In general, the PCR1 resin is sourced from recycled high density polyethylene resin (r-HDPE). For example, the r-HDPE is sourced from packaging waste, such as material generated by households or by commercial, industrial, and institutional facilities in their role as end-users of the product. In a preferred embodiment, the PCR1 resin is sourced from plastic containers, such as plastic bottles, made from HDPE.

In some embodiments, the density of the PCR1 resin is generally from 0.94 g/cc to 0.97 g/cc in one general embodiment; from 0.945 g/cc to 0.965 g/cc in another embodiment; and from 0.95 g/cc to 0.96 g/cc in still another embodiment.

In some embodiments, the melt index of the PCR1 resin is in the range of from 0.01 g/10 min to 1 g/10 min in one general embodiment; from 0.05 g/10 min to 1 g/10 min in another embodiment; and from 0.01 g/10 min to 0.5 g/10 min in still another embodiment.

The PCR1 resin, component (a), used in the blend formulation or formulated resin, can be present in the formulated resin in an amount generally from 20 wt % to 50 wt % in one embodiment; from 20 wt % to 40 wt % in another embodiment; and from 25 wt % to 35 wt % in still another embodiment, based on the total amount of components in the blend formulation.

The at least one second post-consumer recycled (PCR2) resin useful in the formulated blend formulation of the present invention, component (b), includes, for example, one or more recycled polymer resins, wherein the recycled polymer resin is selected from the group consisting of LLDPE, LDPE, HDPE, PP, PA, EVOH, PET, and mixtures thereof. In a preferred embodiment, the PCR2 resin includes, for example, recycled HDPE, recycled LDPE, recycled LLDPE and mixtures thereof.

In another embodiment, the at least one PCR2 resin is recycled LDPE; wherein the recycled LDPE resin has a density of from 0.915 g/cc to 0.935 g/cc, and a melt index, I₂, of from 0.1 g/10 min to 2.0 g/10 mm.

In general, the PCR2 resin is sourced from recycled low density polyethylene (r-LDPE) resin. For example, the r-LDPE resin is sourced from packaging waste, such as material generated by households or by commercial, industrial and institutional facilities in their role as end-users of the product. In a preferred embodiment, the PCR2 resin is sourced from flexible packaging films (e.g., shrink films, logistic films, stretch films, and the like) made from LDPE.

In some embodiments, the density of the PCR2 resin is generally from 0.915 g/cc to 0.935 g/cc in one general embodiment; from 0.916 g/cc to 0.935 g/cc in another embodiment; and from 0.918 g/cc to 0.933 g/cc in still another embodiment.

In some embodiments, the melt index of the PCR2 resin is in the range of from 0.1 g/10 min to 2.0 g/10 min in one general embodiment; from 0.2 g/10 min to 1 g/10 min in another embodiment; and from 0.5 g/10 min to 2.0 g/10 min in still another embodiment.

The PCR2 resin, component (b), used in the blend formulation or formulated resin, can be present in the formulated resin in an amount generally from 20 wt % to 70 wt % in one embodiment; from 25 wt % to 65 wt % in another embodiment; and from 30 wt % to 60 wt % in still another embodiment, based on the total amount of components in the blend formulation.

Component (c) of the formulated resin includes at least one virgin low density polyethylene (v-LDPE) resin; wherein the at least one v-LDPE resin has a density of from 0.915 g/cc to 0.925 g/cc and a melt index, I₂, of from 0.1 g/10 min to 1 g/10 min.

The virgin LDPE resin used in combination with the PCR1 resin and the PCR2 resin to form the blend formulation of the present invention includes, for example, LDPE 150E, LDPE 310E, LDPE 1321, LDPE 611A, AGILITY™ 1500, AGILITY™ 2000, AGILITY™ 2001 (all available from The Dow Chemical Company), and mixtures thereof. In a preferred embodiment, the v-LDPE resin may include, for example, LDPE 150E.

In other embodiments, the v-LDPE resin can also include commercially available compounds such as LDPE 2420D (available from Sinopec Maoming), LUPOLEN LDPE 2420D (available from Lyondellbasell), LDPE LD163 (available from Sinopec Yanshan), and LDPE 1810D (available from CNPC Daqing); and mixtures thereof.

The LDPE resin, component (c), used in the blend formulation, can be present in an amount generally from 10 wt % to 40 wt % in one embodiment; from 20 wt % to 40 wt % in another embodiment, and from 25 wt % to 35 wt % in still another embodiment, based on the total amount of components in the blend formulation.

In another embodiment, the blend formulation or formulated resin of the present invention can include a wide variety of other optional additives. The additives in combination with the composition of the present invention may be formulated to enable performance of specific functions while maintaining the excellent benefits/properties of the blend formulation. For example, the following additives may be blended into the formulated resin to form the CSF formulation of the present invention including: antioxidants, pigments, colorants, UV stabilizers, UV absorbers, processing aids, fillers, slip agents, anti-blocking agents, compatibilizers and the like; and mixtures thereof.

The optional additive, when used in the blend formulation, can be present in an amount generally in the range of from 0 wt % to 10 wt % in one embodiment; from about 0.1 wt % to 5 wt % in another embodiment; and from 1 wt % to 3 wt % in still another embodiment, based on the total amount of components in the blend formulation. In other embodiments the optional additive may be added to the blend formulation in an amount of <5 wt % in one general embodiment, <3 wt % in another embodiment, and <1 wt % in still another embodiment.

In one broad embodiment of the present invention, a process for making the blend formulation or formulated resin includes, for example, mixing or blending components (a), (b) and (c) described above; and any desired optional component (d) different from components (a), (b) and (c), as described above. Both a dry blend process and a compounding process as known to those skilled in the art of mixing polymer resins can be used. In one preferred embodiment, a compounding process is used.

In general, the dry blending process comprises the following steps:
Step (1): weighing the correct proportion of each of the polymer resin components (a), (b), (c), and optionally component (d) described above which are provided in pellet form; and
Step (2): mixing all the polymer pellets together using either a tumble or ribbon blender or any equivalent dry blender.

In general, the compounding (or melt blending) process comprises the following steps:
Step (1): feeding polymer pellets of all the components (a), (b), (c), and optionally component (d) at a feed rate proportional to the respective ratio;
Step (2): melt mixing the polymer pellets in a twin screw extruder or single screw extruder or a continuous mixer or a batch mixer to form a homogeneous melt;
Step (3): filtering the polymer melt using a polymer melt screen changer; and
Step (4): pelletizing the filtered polymer melt using, for example, an under-water pelletizer, a strand pelletizer or hot melt cut into the final blended pellet.

In one preferred embodiment of the present invention, a process for making the blend formulation includes, for example, the steps of:
(I) providing components (a), (b), (c), and optionally component (d) described above; and
(II) mixing or blending or compounding components (a), (b), (c) and optionally component (d) of step (I) at a temperature of from 160° C. to 275° C. and at a pressure of from 5,515 kPa (800 psi) to 22,063 kPa (3,200 psi) in mixing equipment known in the art such as extruders, batch or continuous mixers.

Some of the advantageous/beneficial properties exhibited by the blend formulation produced fabricated according the process of the present invention, can include, for example, the blend formulation can be easily produced, that is, the different components (a), (b), (c), and optionally component (d) of the blend can be dispersed easily and more evenly (uniformly or homogeneously); and the processability of the blend formulation is improved, that is, a CSF film can be readily fabricated from easily processing the blend formulation. The blend also exhibits exceptionally improved aesthetics (e.g., reduced gel/defect count) when fabricated into films while maintaining other mechanical and thermal properties of the film to fulfil the requirement of the target application.

After the blend formulation is prepared by compounding the components (a), (b), (c), and optionally component (d) as described above, the blend formulation is processed to form the formulation into pellets or grains, also referred to as pre-production pellets or nurdles. For example, the materials forming the blend formulation are melt blended (mixed by melting, e.g., via an extruder) to make the formulation. Then, the melt blend formulation is passed from the extruder (e.g., a twin-screw extruder) through a strand die into a pelletizer to form the pellets of the blend formulation. Once made, the pellets are then used to make a shrink film with the desired shrink properties. By pelletizing the blend formulation, the process of transforming the pellets into a film is less complicated and more readily performed.

In one preferred embodiment, the process of making the pellets includes, for example, the steps of:
(I) providing components (a), (b), (c), and optionally component (d) described above;
(II) mixing or blending or compounding components (a), (b), (c), and optionally component (d) of step (I) at a melt temperature (e.g., from 160° C. to 275° C.) in mixing equipment (e.g., a twin-screw extruder); and
(III) forming a blended formulation pellet from the mixture of step (II).

Step (III) of the process above, i.e., forming the blended formulation pellets includes pelletizing the mixture or compounded blended formulation from step (II) using a pelletizer which is equipment known in the art of making pellets. For example, the pellets for making the shrink films of the present invention are obtained by heating and melting the polymer blend formulation and extruding the melted material into strand forms, and then cutting the obtained strands into small tablet forms, so-called pellets.

The size of the pellets made from the pelletized compounded blend formulation is generally from 1.0 mm to 4.0 mm in one embodiment, from 2.0 mm to 3.5 mm in another embodiment, and from 2.5 mm to 3.5 mm in still another embodiment.

The pellets as described above has many advantages when using the pellets to fabricate a shrink film. For example, the pellets exhibit an improved melt strength and a decrease in defect count.

Generally, the melt strength of the pellets is ≥15 cN in one embodiment, from 15 cN to 30 cN in another embodiment, and from 15 cN to 25 cN in still another embodiment.

Various known processes and instruments known in the art for measuring the melt strength of the pellets can be used. In one embodiment, for example, the melt strength (MS) measurements of the pellets are conducted on a Gottfert Rheotens 71.97 (available from Gottfert Inc.; Rock Hill, S.C.) attached to a Gottfert Rheotester 2000 or Rheograph 25 capillary rheometer. The MS test method is described in detail in the Examples.

The Defect Count (DC) number is a measure of the number of defects that are detected in an extruded film using optical imaging technology according the practices and guidance in ASTM D7310-20 “Standard Practice for Defect Detection and Rating of Plastic Film Using Optical Sensors.” The DC number is reported as the number of optical defects per 24.6 cm³ with an effective circular diameter within user defined series of ranges, for example, from 200 μm to 400 μm, from 400 μm to 800 μm, from 800 μm to 1600 μm, and from 1600 μm and above. The method for measuring the DC number is described in detail in the Examples.

The present invention also includes producing collation shrink films which are made from the blend formulation and the blend formulation pellets described above. The collation shrink films of the present invention have a combination of good aesthetics (reduced defects count), toughness (puncture resistance, dart drop impact, tear strength), stiffness (secant modulus), shrink force, contraction force, shrinkage, and processability. A characteristic of shrink films is that such films shrink anisotropically, e.g., the shrink films may shrink from 65% to 85% in the machine direction (MD). Higher shrinkage, shrink force, and contraction force in the MD is used advantageously by circumferentially wrapping articles such that the shrink film's MD direction is oriented in the circumferential wrapping direction.

In one broad embodiment, the process of manufacturing the shrink film of the present invention includes the steps of:
(I) melt-blending the at least one post-consumer recycled resin, component (a), the at least one post-consumer recycled resin, component (b), the at least one virgin low density polyethylene resin, component (c), and any optional additives, thereby making the formulated resin; and
(II) forming at least one monolayer or multi-layer film using blown film extrusion, wherein at least one layer of the extruded film comprises the formulated resin.

In one preferred embodiment, a blown film process, known to those skilled in the art of film making, is used to fabricate the CSF of the present invention. The blown film process for making a blown shrink film generally involves one or more of the following steps: step (1) providing dry pellets of blended formulation, step (2) melting the pellets to form a molten mass, step (3) forming a heated bubble from the resulting molten mass, step (4) collapsing the bubble to form a blown film, and step (5) cutting the collapsed bubble to form a film member or sheet member. Further, the step of forming a heated bubble may include a stretching step, which orients the film.

In another preferred embodiment, the CSF is produced using a blown film process comprising, for example: (I) providing dry pellets of the blend formulation, (II) melting the pellets to form a molten mass, (III) extruding the resulting molten mass using an extrusion process, and (IV) processing the extrusion material through a blown film process to form a shrink film. The blended formulation pellets are optionally and preferably first dried by heating in a dryer to remove surface moisture. The melting step may be carried out at a temperature range of from 165° C. to 230° C. in one embodiment, from 170° C. to 200° C. in another embodiment, and from 175° C. to 200° C. in still another embodiment. The extruding of the blend formulation may take place though a T-style die.

In one broad embodiment of the present invention, the blend formulation described above is used for making a film. The film composition is described above. The film monolayer structure includes, for example, a film sheet of any desired length and width; and has a thickness of, for example, from 20 μm to 100 μm in one general embodiment; from 25 μm to 90 μm in another embodiment; and from 30 μm to 80 μm in still another embodiment.

In one broad embodiment of the present invention, a process for making the monolayer film includes, for example, using any conventional film forming process such as a blown film process and equipment well known to those skilled in the art of forming films.

In some embodiments, the collation shrink film can comprise two or more film substrates combined together to form the CSF used for shrink wrapping articles. For example, the shrink film can be made of three, five, seven, nine or more layers. In one embodiment, the CSF comprises a three-layer film structure including two skin layers and a core layer disposed in between the two skin layers. In another embodiment, the CSF may be a five-layer film structure including a core layer disposed in between two sub-skin layers; and each of the sub-skin layers can be disposed in between the core layer and an outer skin layer.

As described above, the polymer blend formulation or composition used to fabricate a shrink film product comprises: (a) at least one first post-consumer recycled (PCR1) resin, (b) at least one second post-consumer recycled (PCR2) resin and (c) at least one virgin low density polyethylene (v-LDPE) resin; and at least one of the layers of the film structure is at least one layer comprising the blend formulation or formulated resin.

For example, a 3-layer collation shrink film having an A/B/A film structure can be prepared; and the 3-layer collation shrink film can have a 1:2:1 ratio of the first skin layer A, the core layer, and the second skin layer A, respectively. Although a 3-layer collation shrink film is a preferred embodiment, the present invention includes a multi-layer film member with any number of film layers provided that at least one layer of the multi-layer film member includes a PCR resin-containing film layer of the present invention, such as the core layer; and wherein the PCR resin-containing film layer has the proper balance of properties such as stiffness, toughness, and shrinkage. In one embodiment, the film structure of the multi-layer film member can be an A/B/A film wherein each A is a skin layer of the same material; and B is the core layer disposed inbetween the two skin layers A. In another embodiment, the structure of the multi-layer film member can be an A/B/A′ film wherein A is a first skin layer and A′ is a second skin layer of a different material than the first skin layer A; and B is the core layer disposed inbetween skin layers A and A′. In still another embodiment, the structure of the multi-layer film member can be any combination of A, B, and A′ layers which is readily apparent to one skilled in the art of film making.

Similarly, a five-layer collation shrink film having an A/B/C/B′/A′ film structure can be prepared wherein A is a skin layer or the most outer layer of the film; B is a toughness-promoting sub-skin layer; C is a core layer; B′ is another toughness-promoting sub-skin layer; and A′ is an inner most layer of the film. The sub-skin layer B is disposed in between the outer layer A and the core layer C; and the other sub-skin layer B′ is disposed in between the inner layer A′ and the core layer C. The outer layer A and the inner layer A′ can be made of the same material or different materials. The B sub-skin layer and the B′ sub-skin layer can be made of the same material or different materials.

For the various films described herein, the A and A′ layers can be formed of any material known in the art for use in multilayer films. Thus, for example, the A layer and/or the A′ layer can be formed of a polyethylene (homopolymer or copolymer), or a blend of two or more polyethylene polymers; and the polyethylene can be selected from the group consisting of, for example, VLDPE, LDPE, LLDPE, MDPE, HDPE, and mixtures thereof, as well as other polyethylenes known in the art. In another example, the A and/or A′ layer can be formed of a polyethylene (homopolymer or copolymer), a non-polyethylene polymer, e.g., a polypropylene, or a blend of a polyethylene, a non-polyethylene polymer, and mixtures thereof.

In multilayer film structures, one or more of the B and/or B′ layers as toughness-promoting sub-skin layers, can include for example, INNATE™ ST50 precision packaging resin (available from The Dow Chemical Company); ethylene-vinyl acetate copolymers; and mixtures thereof.

In some preferred embodiments, the core layer of the three-layer CSF structure and of the five-layer CSF structure includes a layer fabricated from the polymer blend formulation as described above, i.e., wherein the formulated resin includes (a) at least one PCR1 resin, (b) at least one PCR2 resin and (c) at least one v-LDPE resin; and any optional additives if desired.

As an illustration of the film structure, and not to be limited thereby, a three-layer film structure of an A/B/A′ construction is described herein below wherein A is the first skin layer, B is the core layer, and A′ is the second skin layer. For example, the skin layer A of the CSF product can be made of one or more materials, including, for example, HDPE, LDPE, MDPE, LLDPE, and mixtures thereof. In one preferred embodiment, the material of the at least one first skin layer useful in the present invention can be HDPE, LDPE, LLDPE, and mixtures thereof.

Exemplary of some of the commercial materials useful in the first skin layer of the present invention can include, for example, DOWLEX™ 2045G, DOWLEX™ NG 5045P, DOWLEX™ 2645G, DOWEX™ 2049G, DOWLEX™ 2038.68G, DMDA-6200 NT 7, DMDA-6400 NT 7, DOWLEX GM 8070G, LDPE 611A, AGILITY™ 2000, AGILITY™ 1023, DOW™ LDPE 150E, and DOW™ LDPE 310E (all available from The Dow Chemical Company); ENABLE™ 2703 and ENABLE™ 3505 (both available from ExxonMobil); LUTENE™ BE0400 (available from LG Chem); and mixtures thereof.

The thickness of the first skin layer used in the present invention film is, for example, from 8 μm to 30 μm in one embodiment, from 10 μm to 25 μm in another embodiment and from 12 μm to 20 μm in still another embodiment.

In one preferred embodiment, the first skin layer is a combination of LDPE, LLDPE and HDPE. The LDPE has a density of from 0.915 g/cc to 0.925 g/cc and a melt index, I₂, of from 0.1 g/10 min to 2 g/10 min; the LLDPE has a density of from 0.915 g/cc to 0.94 g/cc and a melt index, I₂, of from 0.2 g/10 min to 2 g/10 min; and the HDPE has a density of from 0.945 g/cc to 0.965 g/cc and a melt index, I₂, of from 0.04 g/1 min to 1 g/10 min.

The second skin layer A′ of the present invention film can be made of the same material as the first skin layer A as described above; or in an alternative embodiment, the second skin layer A′ can be made of one or more materials different from the first skin layer A, including, for example, HDPE, LDPE, LLDPE, MDPE, and mixtures thereof. In one preferred embodiment, the material of the second skin layer useful in the present invention can be material selected from the group consisting of HDPE, LDPE, LLDPE and mixtures thereof. In another preferred embodiment, the material of the second skin layer A′ is the same material as the first skin layer A.

Exemplary of some of the commercial materials useful in the second skin layer of the present invention can include, for example, DOWLEX™ 2045G, DOWLEX™ NG 5045P, DOWLEX™ 2645G, DOWEX™ 2049G, DOWLEX™ 2038.68G, DMDA-6200 NT 7, DMDA-6400 NT 7, DOWLEX GM 8070G, LDPE 611A, AGILITY™ 2000, AGILITY™ 1023, DOW™ LDPE 150E, and DOW™ LDPE 310E (all available from The Dow Chemical Company); ENABLE™ 2703 and ENABLE™ 3505 (both available from ExxonMobil); LUTENE™ BE0400 (available from LG Chem); and mixtures thereof.

The thickness of the second skin layer used in the present invention film is, for example, from 8 μm to 30 μm in one embodiment, from 10 μm to 25 μm in another embodiment and from 12 μm to 20 μm in still another embodiment.

In one preferred embodiment, the second skin layer can be made of a combination of LDPE and LLDPE. The LDPE can have a density of from 0.915 g/cc to 0.925 g/cc and a melt index, I₂, of from 0.1 g/10 min to 2 g/10 min; and the LLDPE can have a density of from 0.915 g/cc to 0.94 g/cc and a melt index, I₂, of from 0.2 g/10 min to 2 g/10 min.

The PCR resin-containing core layer B (i.e., the PCR resin-containing middle layer disposed between the first and second skin layers) of the present invention film is made of one or more materials, including, for example, HDPE, MDPE, LDPE, LLDPE, and mixtures thereof, provided that at least two of the polymers is sourced from recycled polymers or materials. In one preferred embodiment, the recycled polymer material of the core layer B useful in the present invention can include r-HDPE, r-LDPE and mixtures thereof.

Exemplary of some of the commercial materials useful in the PCR resin-containing core layer of the present invention can include, for example, DOWLEX™ 2045G, DOWLEX™ NG 5045P, DOWLEX™ 2645G, DOWEX™ 2049G, DOWLEX™ 2038.68G, DMDA-6200 NT 7, DMDA-6400 NT 7, TUFLIN™ HS-7072, DOW™ LDPE 150E, DOW™ LDPE 310E, DOW™ LDPE 1321, AGILITY™ 2000, and AGILITY™ 1500, (all available from The Dow Chemical Company); ENABLE™ 2703 and ENABLE™ 3505 (both available from ExxonMobil); LUTENE™ BE0400 (available from LG Chem); and mixtures thereof.

The thickness of the PCR resin-containing core layer used in the present invention film is, for example, from 20 μm to 60 μm in one embodiment, from 25 μm to 55 μm in another embodiment and from 30 μm to 50 μm in still another embodiment.

The PCR resin loading level of the PCR resin-containing core layer is generally from 10 wt % to 80 wt % in one embodiment, and from 10 wt % to 70 wt % in another embodiment.

The density of the PCR resin-containing core layer is generally from 0.925 g/cc to 0.940 g/cc in one embodiment, from 0.930 g/cc to 0.940 g/cc in another embodiment, and from 0.930 g/cc to 0.935 g/cc in still another embodiment.

The melt index of the PCR resin-containing core layer is generally from 0.1 g/10 min to 1.0 g/10 min in one embodiment, from 0.15 g/10 min to 0.8 g/10 min in another embodiment, and from 0.15 g/10 min to 0.5 g/10 min in still another embodiment.

In one broad embodiment of the present invention, a process for making the film of the present invention includes, for example, using any conventional film forming process such as a blown film process and equipment well known to those skilled in the art of forming films. In general, for example, a blown film process is used to manufacture the CSF. As an illustration of the blown film process, and not to be limited thereby, a blown film such as a three-layer film described herein and prepared in the Examples herein below, with a layer ratio of 1/2/1 can be produced on a conventional blow line (for example, a blow line manufactured by Battenfeld Gloucester) using typical fabrication parameters easily determined by those skilled in the art of producing blown film.

Some of the advantageous properties exhibited by CSF product made by the above process of the present invention can include, for example, good shrink performance as measured by shrink force and contraction force, wherein the shrink force is >100 mN and wherein the contraction force is >2,500 mN in the machine direction (ISO 14616). The CSF product also exhibits good toughness as measured by puncture resistance, dart impact resistance, and Elmendorf tear strength, wherein the puncture resistance is >3.3 MPa (40 ft*lbf/in³) as measured by the procedure described in ASTM D5748, wherein the dart impact resistance is >70 g as measured by the procedure described in ASTM D1709 Type A, and wherein the Elmendorf tear strength is >100 gf in the machine direction as measured by the procedure described in ASTM D1922 Type B (Constant radius). The CSF product also exhibits good processability as measured by melt strength, wherein the melt strength is >15 cN. The CSF product prepared as described above can be used, for example, in packaging applications.

In a preferred embodiment, a CSF structure incorporating a certain amount of PCR resin (e.g., 70% PCR resin) can have similar properties compared to a film made from a polyethylene virgin resin (e.g., a virgin LDPE resin).

The collation shrink film of the present invention is a packaging film used to collate groups of articles into a unitized package for the purpose of handling, shipping, distribution and final sale. Non-limiting examples of articles that can be wrapped with the collation shrink film include: cans of food; bottles or cans of beverages such as water, soft drinks, beer, energy drinks, and liquid protein drinks; and multipacks of bottles or cans.

In general, the collation shrink film is applied to (e.g., wrapped around) one or more articles or items and then the shrink film with wrapped articles or items is placed under a heat source to shrink the film resulting in a unitized package of wrapped articles/items ready for handling, shipping, distribution, and final sale. Suitable performance characteristics on the shrink-packaging line include sufficient stiffness allowing the film to be correctly wrapped around the items being packaged, sufficient dimensional shrinkage to ensure a snug fit, and a sufficiently low Coefficient of Friction (COF) for machinability and package handling.

As illustrated by the following Examples, the collation shrink films of the present invention have a high thermal shrink force to ensure a tight fit and a high tensile strength to withstand handling and abuse during transportation. In addition, the packaging has excellent display properties including haze (or “contact clarity”) and clarity (“see-through clarity”). Also, other properties such as a low melt pressure, and an ability to use low motor power, are properties that advantageously allow manufacturers of films to provide higher production rates.

### EXAMPLES

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise, stated all parts and percentages are by weight on a total weight basis.

Various terms, designations, and raw materials used in the Inventive Examples (Inv. Ex.) and the Comparative Examples (Comp. Ex.) are explained as follows:
“PCR” stands for post-consumer recycled.
“LDPE” stands for low density polyethylene.
“HDPE” stands for high density polyethylene.
“r-LDPE Natural” stands for recycled low density polyethylene.
“r-HDPE Natural” stands for recycled high density polyethylene.
“Natural”, with reference to a resin, means no pigments are present in the resin.

### Raw Materials

The ingredients/raw materials used in the Examples are described as follows:
“PCR1” is a post-consumer recycled resin material having a formulation of r-LDPE Natural 510A/r-HDPE Natural 921D/LDPE 150E (50/30/20, respectively) and having a PCR resin loading of 80 wt %.
“PCR2” is a post-consumer recycled resin material having a formulation of r-LDPE Natural 510A/r-HDPE Natural 921D/LDPE 150E (40/30/30, respectively) and having a PCR resin loading of 70 wt %.
“ResinA” is a control resin having a single source of PCR resin at a loading of up to 40 wt %; and ResinA is available from The Dow Chemical Company as XUS 60921.01.
LDPE 150E (ResinB) is a low density polyethylene resin available from The Dow Chemical Company.
r-LDPE Natural 510A (ResinC) is a recycled low density polyethylene resin material available from PT Elite. The designated term “Natural” in the above polymer refers to the color of the resin which is a natural color.
r-HDPE Natural 921D (ResinD) is a recycled high density polyethylene resin material available from PT Elite. The designated term “Natural” in the above polymer refers to the color of the resin which is a natural color.

Some of the properties of the ingredients/raw materials used in the Examples are described in Table I.

TABLE I
Properties of Raw Materials

| | I₂ | | Density |
|---|---|---|---|
| Raw Material | (g/10 min) | I₁₀/I₂ | (g/cc) |
| PCR1 resin | 0.18 | 15.1 | 0.933 |
| PCR2 resin | 0.26 | 16.5 | 0.933 |
| ResinA (Control) | 0.35 | 12.1 | 0.940 |
| ResinB (LDPE 150E) | 0.26 | 15.8 | 0.922 |
| ResinC (r-LDPE Natural 510A) | 0.84 | 8.8 | 0.928 |
| ResinD (r-HDPE Natural 921D) | 0.06 | 23.0 | 0.951 |

### Resin Formulations

### General Procedure for Preparing Resin Formulations

The polymer resin formulation samples described in Table II were compounded in accordance with the following general procedure:

To produce the polymer resin formulation, the various polymer pellets (PCR resin pellets and virgin polymer pellets) were melt blended in either a co-rotating twin screw extruder (TSE), a single screw extruder (SSE), a continuous mixer, or a Banbury batch mixer. A 40 mm Coperion co-rotating twin screw extruder with a L/D of 44 was used to melt mix and homogenize the polymer resin formulation. The various polyethylene (PCR resin and virgin resin) pellets were fed into the feed hopper of the TSE hopper using separate K-Tron gravimetric feeders. The TSE barrels were set between a temperature of from ambient to 240° C. and the screw speed of the extruder was set at 300 rpm. The polymer pellets were fed at a rate proportional to the formulation with the total throughput rate of 200 lb/hr (0.0252 Kg/s). The final polymer pellets were melt mixed in the TSE followed by melt filtration using a polymer melt screen changer having a screenpack configuration of 20/40/100/40/20 mesh. The filtered polymer melt was then pelletized using a Gala underwater pelletizer to provide pellets with a pellet size corresponding to 32 pellets/gm.

In one embodiment, the PCR1 resin blend formulation prepared according to the above general procedure had the following make up: The PCR1 resin was an 80% PCR resin formulation with a 50/30/20 blend corresponding to r-LDPE Natural 510A/r-HDPE Natural 921D/LDPE 150E.

In another embodiment, the PCR2 resin blend formulation prepared according to the above general procedure had the following make up: The PCR2 resin was a 70% PCR resin formulation with a 40/30/30 blend corresponding to r-LDPE Natural 510A/r-HDPE Natural 921D/LDPE 150E.

ResinA was a PCR resin-containing resin containing 40% HDPE PCR resin; and ResinA (XUS 60921.01) is commercially available from The Dow Chemical Company.

ResinB, ResinC, and ResinD were DOW™ LDPE 150E resin, r-LDPE Natural 510A resin, and r-HDPE Natural 921D resin, respectively, which were used “as is” when received from the supplier.

The resin formulations used to fabricate the various CSF samples to be tested are described in Table II.

TABLE II
Resin Formulations

| | | Formulation | | | | |
|---|---|---|---|---|---|---|
| | | | | | | PCR |
| | | Component | Component | Component | Component | Loading |
| Example No. | Resin | (a) | (b) | (c) | (d) | (wt %) |
| Comp. Ex. A | ResinA (Control) | — | — | — | — | 40 |
| Comp. Ex. B | ResinB | LDPE 150E | — | — | — | 0 |
| Comp. Ex. C | ResinC | r-LDPE Natural 510A | — | — | — | 100 |
| Comp. Ex. D | ResinD | r-HDPE Natural 921D | — | — | — | 100 |
| Inv. Ex. 1 | PCR1 resin | 50 wt % r-LDPE | 30 wt % r-HDPE | 20 wt % | None | 80 |
| | | Natural 510A | Natural 921D | LDPE 150E | | |
| Inv. Ex. 2 | PCR2 resin | 40 wt % r-LDPE | 30 wt % r-HDPE | 30 wt % | None | 70 |
| | | Natural 510A | Natural 921D | LDPE 150E | | |

### Film Samples

### General Procedure for Preparing CSFs

The CSF samples used in the Examples were blown films and a blown film process was used to fabricate the CSFs. Each of the CSF sample films had a three-layer film structure of A/B/A (skin layer/core layer/skin layer) construction with a layer ratio of 1/2/1 or 25/50/25, respectively. Each of the CSF sample films had a total thickness of 60 μm. Each of the skin layers A had a film structure of 40/40/20 DOWLEX 2045G/LDPE 150E/DMDA 6400. The core layer B of each of the CSF samples was used to distinguish the Comp. Ex. from the Inv. Ex. The following four films having an A/B/C film structure were used as the Core Layer B:
Film #1—Reference: 40/40/20 DOWLEX 2038.68G/LDPE 150E/DMDA 6400.
Film #2—Control: XUS 60921.01.
Film #3—80% PCR: Compounded 50/30/20 corresponding to r-LDPE Natural 510A/r-HDPE Natural 921D/LDPE 150E.
Film #4—70% PCR: Compounded 40/30/30 corresponding to r-LDPE Natural 510A/r-HDPE Natural 921D/LDPE 150E.

The 3-layer (A/B/C structure) CSF film samples were blown using an Alpine line manufactured by Hosokawa Alpine. The fabrication parameters/conditions for the films were as follows:
(1) Blow up ratio (BUR): 3.0
(2) Gauge: 2.36 mil (60 μm)
(3) Die Gap: 78.7 mil (2.0 mm)
(4) Die Size: 9.84 inches (250 mm)
(5) Output: 140.6 kg/hr (310 lbs/hr)
(6) Line speed: 60 ft/min (0.3048 m/s)
(7) Draw-down Ratio: 11.1

The formulations described in Table II were used to fabricate the various CSF samples described in Table III.

TABLE III
Collation Shrink Films

| Example | | | | |
|---|---|---|---|---|
| No. | Film | Skin Layer 1 | Core Layer | Skin Layer 2 |
| Comp. Ex. E | Reference | 40/40/20 | 40/40/20 | 40/40/20 |
| | | DOWLEX 2045G/LDPE | DOWLEX 2045G/LDPE | DOWLEX 2045G/LDPE |
| | | 150E/DMDA 6400 | 150E/DMDA 6400 | 150E/DMDA 6400 |
| Comp. Ex. F | Control | 40/40/20 | Control: XUS 60921.01 | 40/40/20 |
| | | DOWLEX 2045G/LDPE | | DOWLEX 2045G/LDPE |
| | | 150E/DMDA 6400 | | 150E/DMDA 6400 |
| Inv. Ex. 3 | CSF-1 | 40/40/20 | 50/30/20 | 40/40/20 |
| | | DOWLEX 2045G/LDPE | r-LDPE Natural 510A/r-HDPE | DOWLEX 2045G/LDPE |
| | | 150E/DMDA 6400 | Natural 921D/LDPE 150E | 150E/DMDA 6400 |
| Inv. Ex. 4 | CSF-2 | 40/40/20 | 40/30/30 | 40/40/20 |
| | | DOWLEX 2045G/LDPE | r-LDPE Natural 510A/r-HDPE | DOWLEX 2045G/LDPE |
| | | 150E/DMDA 6400 | Natural 921D/LDPE 150E | 150E/DMDA 6400 |

### Testing Methods

### Density

Unless indicated otherwise, all densities disclosed herein were measured according to ASTM D792-08, Method B, and are reported in units of grams per cubic centimeter (g/cm³ or g/cc).

### Melt Index (I₂)

Unless indicated otherwise, all melt indices (I₂) disclosed herein were measured according to ASTM D1238-10, Method B, at 190° C. and a 2.16 kg load, and are reported in grams eluted per 10 minutes (g/10 min).

### Melt Flow Rate (I₁₀)

Unless indicated otherwise, all melt flow rates (I₁₀) disclosed herein were measured according to ASTM D1238-10, Method B, at 190° C. and a 10 kg load, and are reported in grams eluted per 10 minutes (g/10 min).

### Melt Strength

The melt strength (MS) measurements of the pellets were conducted on a Gottfert Rheotens 71.97 (available from Gottfert Inc.; Rock Hill, S.C.) attached to a Gottfert Rheotester 2000 or Rheograph 25 capillary rheometer. The MS of the pellets was measured at 190° C. by feeding a polymer melt of the pellets to the Göettfert Rheotens 71.97 using the Göettfert Rheotester 2000 capillary rheometer equipped with a flat entrance angle (180 degrees) of length of 30 mm and diameter of 2 mm and an aspect ratio (capillary length/capillary diameter) of 15. A blended formulation melt (e.g., about 20 g to 30 g, pellets) was extruded through the capillary die. The pellets were fed into the barrel (L=300 mm, Diameter=12 mm), compressed and allowed to melt at 190° C. for 10 min before being extruded at a constant piston speed of 0.265 mm/s, which corresponds to a wall shear rate of 38.2 s⁻¹ at the given die diameter. The extrudate was passed through the wheels of the Rheotens located at 100 mm below the die exit and the extrudate was pulled by the wheels downward at an acceleration rate of 2.4 mm/s². The force (in “cN”) exerted on the wheels was recorded as a function of the velocity of the wheels (in mm/s). Melt strength was reported as the plateau force (cN) before the strand breaks. Drawability is the maximum velocity at which the polymer strand breaks up.

### Defect Count Number

The Defect Count (DC) number is a measure of the number of defects that are detected in an extruded film using optical imaging technology according the practices and guidance in ASTM D7310-20 “Standard Practice for Defect Detection and Rating of Plastic Film Using Optical Sensors.” The DC number was reported as the number of optical defects per 24.6 cm³ with an effective circular diameter within a user's defined series of ranges. For example, the ranges can be from 200 μm to 400 μm, from 400 μm to 800 μm, from 800 μm to 1600 μm, and from 1600 μm and above. The DC number was measured by an Optical Control Systems (OCS) Film Surface Analyzer FSA100 (OCS FSA100) optical imaging system. The OCS FSA100 optical imaging system consisted of a lighting unit (e.g., a halogen-based source light), a charge-coupled device (CCD) line scan camera, and a computer with image/data analysis software version 5.0.4.6.

The OCS FSA100 optical imaging system detected defects as the defects obscured the transmission of halogen-based source light. Average greyscale was set to 170 with a threshold sensitivity setting of 35%. Additionally, the gain of the CCD system was adjusted to compensate for film haziness. The imaging system created a composite area of each defect by adding the defective pixels from each subsequent line scan. The system then reported the number of defects which were in the aforementioned user's defined size ranges, based on the diameter of circles having equivalent areas.

In one embodiment, the DC number measured, wherein the defect had an equivalent circular diameter in the range of from 200 μm to 400 μm (per 24.6 cm³ of film) was, for example, ≤20,000 when measured according to the method described herein; and in another embodiment, the DC number, wherein the defect had an equivalent circular diameter in the range of from 400 μm to 800 μm (per 24.6 cm³ of film) was, for example ≤1,000 when measured according to the method described herein.

Film fabrication was accomplished by an OCS ME19 cast film extrusion system equipped with a fixed lip coat hanger die. The die gap was 500 μm by 15 cm. The extruder used was a single screw extruder equipped with a 19 mm screw provided by OCS. The screw design was a 3:1 LID compression ratio with a pineapple mixing tip. The total extrusion system mass output was 10 kg/hr±5 kg/hr. The film thickness prepared was 38 μm, which was achieved via adjustment of the chill roll. A nitrogen purge was used at the feed throat of the extruder. The temperature profiles of the extrusion ranged from 135° C. to 190° C. to achieve a target extrusion pressure of 220 Bar to 240 Bar.

### Processability

The processability of the CSF fabricated as described above was measured by the average head pressure before the screen pack when the films were made on the Alpine line. Average head pressure before the screen pack and average pressure after screen are two melt pressures read from two different locations on each extruder. The first reading was measured after the extruder and just before the screen changer. The second reading was taken after the screen changer.

### Haze

Film haze was measured according to ASTM D1003 using a BYK Haze-Gard plus. The film was conditioned for at least 40 hr after film production at 23° C. (+/−2° C.) and 50% relative humidity (RH) (+/−10%) as per ASTM standards. The standard testing conditions were 23° C. (+/−2° C.) and 50% RH (+/−10%) as per ASTM standards.

For each sample to be tested, five separate specimens, 15.24 cm×15.24 cm (6 inches×6 inches), were prepared. The thickness of the specimen was measured and the specimen was then placed on a plastic ring. A metal ring was then used to clamp the specimen to the inside of the plastic ring such that there were no obvious wrinkles in the film. To obtain Total Haze, the clamped specimen was then placed on the haze port of the sensing unit, with the film flush against the entrance port and a haze reading was taken. This was repeated for all 5 specimens. To obtain Internal Haze, a small amount of mineral oil was placed on both surfaces of the film and the oil was spread evenly using a cotton swab. The sample was then placed as close as possible to the haze port and a reading was taken. Again, this was repeated for all 5 specimens. Surface Haze was calculated from the difference between Total Haze and Internal Haze.

### Puncture

The Standard Test Method for Protrusion Puncture Resistance used in the Examples was based on ASTM D5748. The above-mentioned Puncture test was used to determine the resistance of a film to the penetration of a probe at a standard low rate, single test velocity. The film was conditioned for at least 40 hr after film production at 23° C. (+/−2° C.) and 50% RH (+/−10%) as per ASTM standards. The standard testing conditions were 23° C. (+/−2° C.) and 50% RH (+/−10%) as per ASTM standards. Puncture was measured on a tensile testing machine. Square specimens were cut from a sheet to a size of approximately 15.24 cm×15.24 cm (6 inches by 6 inches). The specimen was clamped in a 10.16-cm (4-inch) diameter circular specimen holder and a puncture probe was pushed into the center of the clamped film at a cross head speed of 25.4 cm/min (10 inches/min). The probe used in the Examples was a 1.27 cm (0.5-inch) diameter polished steel ball on a 0.635 cm (0.25-inch) diameter support rod which was a slight deviation from the above ASTM standard procedure. A single thickness measurement was made in the center of the specimen. For each specimen, the maximum force, force at break, penetration distance, energy to break and puncture strength (energy per unit volume of the sample) was determined. A total of 5 specimens were tested to determine an average puncture value. The puncture probe was cleaned using a “Kim-wipe” after each specimen.

### Dart Drop Impact

The Dart Drop test was used to determine the energy that causes plastic film to fail under specified conditions of impact by a free-falling dart. The test result was the energy, expressed in terms of the weight of the missile falling from a specified height, that would result in failure of 50% of the specimens tested.

The film was conditioned for at least 40 hr after film production at 23° C. (+/−2° C.) and 50% RH (+/−10%) as per ASTM standards. The standard testing conditions were 23° C. (+/−2° C.) and 50% RH (+/−10%) as per ASTM standards.

Method A of the test was used which includes use of a 3.81 cm (1.5-inch) diameter dart head and a 66.04 cm (26-inch) drop height. The sample thickness was measured at the sample center and the sample then clamped by an annular specimen holder with an inside diameter of 12.7 cm (5 inches). The dart was loaded above the center of the sample; and then the dart was released by either a pneumatic or electromagnetic mechanism.

Testing of the specimens was carried out according to the “staircase method”. This method provides that if a sample fails, a new sample is tested with the weight of the dart reduced by a known and fixed amount; and if the sample does not fail, a new sample is tested with the weight of the dart increased by a known increment. A total of 20 specimens were tested and the number of failures was determined. After testing 20 test specimens, if the number of failures was 10 then the testing was completed; and if the number of failures was <10, the testing of more test specimens was continued until 10 failures were recorded. If the number of failures was >10, then the testing of more test specimens was continued until the total number of non-failures was 10. The Dart drop strength was determined from the above data obtained per ASTM D1709.

### Elmendorf Tear

The method described in ASTM D1922 Type B (Constant radius) was used to measure Elmendorf tear. The above Elmendorf Tear test determines of the average force to propagate tearing through a specified length of plastic film or nonrigid sheeting after the tear has been started using an Elmendorf-type tearing tester.

The film to be tested was first conditioned for at least 40 hr after film production at 23° C. (+/−2° C.) and 50% RH (+/−10%) as per ASTM standards. The standard testing conditions were 23° C. (+/−2° C.) and 50% RH (+/−10%) as per ASTM standards.

The force in grams required to propagate tearing across a film or sheeting specimen was measured using a precisely calibrated pendulum device. Acting by gravity, a pendulum was swung through an arc, tearing the specimen from a precut slit. The specimen was held on one side by the pendulum and the other side of the specimen was held by a stationary member. The loss in energy by the pendulum was indicated by a pointer or by an electronic scale. The scale indication is a function of the force required to tear the specimen. The sample used was the “constant radius geometry” as specified in D1922. Testing was carried out on samples that have been cut from both the MD and CD directions. Prior to testing, the sample thickness was measured at the sample center. A total of 15 specimens per direction were tested and average tear strength was reported.

### Secant Modulus 2%

The method described in ASTM D882 was used to measure secant modulus 2%. The above tensile test was used to measure the properties of a film when tested under uniaxial extension. The secant modulus was measured at a specified strain; and the secant modulus was reported as the ratio of the stress at the specified strain to the specified strain, as determined from the load—extension curve.

The film was first conditioned for at least 40 hr after film production at 23° C. (+/−2° C.) and 50% RH (+/−10%) as per ASTM standards. The standard testing conditions were 23° C. (+/−2° C.) and 50% RH (+/−10%) as per ASTM standards.

Test strips, 2.54 cm (one-inch) wide, were cut from the film to be tested, and then the test strips were loaded in a tensile testing frame using line contact grips at a contact point (gauge length) separation of 10.16 cm (4 inches). Samples were tested at a crosshead speed of 5.08 cm/min (2 inches/min) up to a nominal strain of 5%. The elastic modulus (from the initial portion of the stress-strain curve, often referred to as the Young's Modulus) and secant modulus at 1% and 2% strain were calculated.

### Shrink Force, Shrinkage, and Contraction Force

Shrink force and shrinkage were measured using “Retratech” equipment. In this method, films strips of 15 mm width and 100 mm length were used as test specimens, cut either along the machine direction (MD) or the cross-direction (CD). Two specimens were free to have motion, and six specimens were constrained from any motion in the direction of test (MD or CD). The two specimens that were free to move were used to measure free-shrinkage and the constrained six specimens were used to measure shrink force. The test strips were subjected to a sudden increase in temperature as an oven pre-heated to a chosen temperature (setpoint) was mechanically engaged to cover the specimens initially at ambient temperature. The specimens shrunk physically and the amount of shrinkage of the specimens was measured using a displacement sensor which was connected to one end of the specimens.

The specimens used for determining the shrink force of the specimens were connected to load cells which provided a force-signal. These measurements were available as a function of time as the temperature about the specimens change during the test. The temperature profile experienced by the film specimens was a result of the test conditions chosen which, in turn, affected test data.

There were usually two methods of choosing test conditions (oven-temperature setpoint, dwell time and total time): (1) the method describe in ISO 14616; and (2) a fixed condition method. In the above method (1), test conditions were chosen to comply with ISO 14616 requirements for the MD specimens. In the above method (2), a fixed set of temperature setpoints and dwell times were set for all samples, with the values of the samples chosen to achieve a well-defined peak of force in the MD during temperature-rise phase which would eventually relax down to zero before the oven was disengaged. When the oven was disengaged prior to the force specimens relaxing to zero-force (during ISO 14616 method), there occurred a rise in force with the film specimens cooling down. The force peak during temperature rise was termed “Shrink Force”, the maximum shrinkage at the end of the total analysis time was termed “Free Shrinkage”, and the force at the end of the analysis time was termed “Contraction Force”.

### Results

Table IV describes the DC number of the CSF film samples tested according to the procedure for measuring DC number as described above.

TABLE IV
Defect Count Number

| | | Number of Optical Defects* | | | |
|---|---|---|---|---|---|
| | | 200-400 | 400-800 | 800-1600 | >1600 |
| Example No. | Resin | μm | μm | μm | μm |
| Inv. Ex. 1 | PCR1 resin | 18,263 | 769 | 9 | 0 |
| Inv. Ex. 2 | PCR1a resin (dry blend) | 30,077 | 1,881 | 47 | 1 |
| Inv. Ex. 3 | PCR2 resin | 8,196 | 469 | 17 | 0 |
| Inv. Ex. 4 | PCR2a resin (dry blend) | 23,266 | 1,371 | 41 | 1 |
| Comp. Ex. A | Control | 21,925 | 2,860 | 209 | 0 |
| Comp. Ex. B | LDPE 150E | 3,007 | 268 | 10 | 3 |
| Comp. Ex. C | r-LDPE Natural 510A | 85,067 | 5,115 | 59 | 0 |
| Comp. Ex. D | r-HDPE Natural 921D | NP** | NP | NP | NP |

Notes for Table IV:
*The defect count (DC) number of films is reported as the number of optical defects per 24.6 cm³ with an effective circular diameter within the defined series of ranges in microns.
**“NP” stands for “not processable”, i.e., the processability of the r-HDPE sample of Comp. Ex. D is too poor to be extruded into films for measuring gel counts.

Table V describes the mechanical properties of the CSF film samples tested according to the procedures described above.

TABLE V
Mechanical Properties of CSF Films

| | | | | | | | | Puncture - | Puncture - | |
|---|---|---|---|---|---|---|---|---|---|---|
| | | 2% Secant | 2% Secant | | | | | Average | Average | |
| | | Modules | Modules | Tear | Tear | | | Elongation | Elongation | |
| Example | | (MD) | CD) | MD | CD | Puncture | Puncture | At Break | At Break | Dart A |
| No. | Film | (MPa) | (MPa) | (gf) | (gf) | (ft*lbf/in³) | (kPa) | (inches) | (cm) | (g) |
| Comp. Ex. E | Reference | 54,513 | 65,672 | 233.0 | 739.2 | 48.3 | 3,996.2 | 2.0 | 5.08 | 84 |
| Comp. Ex. F | Control | 58,439 | 71,071 | 48.1 | 1029.6 | 28.6 | 2,366.3 | 1.4 | 3.56 | 82 |
| Inv. Ex. 3 | CSF-1 | 41,559 | 53,038 | 107.2 | 898.0 | 46.7 | 3,863.8 | 2.0 | 5.08 | 85 |
| Inv. Ex. 4 | CSF-2 | 47,018 | 54,172 | 126.6 | 873.8 | 46.4 | 3,839.0 | 2.0 | 5.08 | 86 |

Table VI describes the optical properties of the CSF film samples tested according to the procedures described above.

TABLE VI
Optical Properties

| | | Haze |
|---|---|---|
| Example No. | Film | (%) |
| Comp. Ex. E | Reference | 47.30 |
| Comp. Ex. F | Control | 50.74 |
| Inv. Ex. 3 | CSF-1 | 45.06 |
| Inv. Ex. 4 | CSF-2 | 45.52 |

Table VII describes the shrink performance of the CSF film samples tested according to the procedures described above.

TABLE VII
Shrink Performance

| | | Shrink | Shrink | Contraction | Contraction | |
|---|---|---|---|---|---|---|
| | | Force MD - | Force CD - | Force MD - | Force CD - | Shrinkage MD |
| | | ISO 14616 | ISO 14616 | ISO 14616 | ISO 14616 | (200° C., 50 s) |
| Example No. | Resin | (mN) | (mN) | (mN) | (mN) | (%) |
| Comp. Ex. E | Reference | 141.8 | 1.9 | 3024.0 | 1547.1 | 73.4 |
| Comp. Ex. F | Control | 102.5 | 1.8 | 3165.5 | 1488.8 | 70.2 |
| Inv. Ex. 3 | CSF-1 | 111.3 | 1.4 | 2990.7 | 830.2 | 71.7 |
| Inv. Ex. 4 | CSF-2 | 102.5 | 1.2 | 2753.5 | 926.7 | 70.9 |

Table VIII describes the processability performance of the CSF film samples tested according to the procedures described above and based on the head and after screen pressures measured.

TABLE VIII
Processability Performance

| | | Avg Head | Avg Head | Avg Pressure | Avg Pressure |
|---|---|---|---|---|---|
| | | Pressure | Pressure | After Screen | After Screen |
| Example No. | Resin | (psi) | (kPa) | (psi) | (kPa) |
| Comp. Ex. E | Reference | 6,694 | 46,153.510 | 4,985 | 34,370.365 |
| Comp. Ex. F | Control | 6,486 | 44,719.396 | 4,784 | 32,984.519 |
| Inv. Ex. 3 | CSF-1 | 6,227 | 42,933.654 | 4,620 | 31,853.780 |
| Inv. Ex. 4 | CSF-2 | 5,904 | 40,706.647 | 4,402 | 30,350.722 |

### Discussion of Results

The results described in Tables V-VII, show that the collation shrink films (CSFs) of Inv. Ex. 3 and 4 have quite good mechanical properties which are very important for collation shrink film applications; and when the CSFs of Inv. Ex. 3 and 4 are compared to the film of Comp. Ex. E (no PCR resin), the optical performance of the CSFs of Inv. Ex. 3 and 4 with PCR resin are almost at the same level as the film of Comp. Ex. E.

The CSFs of Inv. Ex. 3 and 4 show a very good shrink performance, even better than the films of Comp. Ex. E and F. Good shrink performance of a CSF is a very important property for collation shrink film applications. The results described in Tables V-VII above, also show that while the CSFs of Inv. Ex. 3 and 4, incorporating two different post-consumer recycled (PCR) resin materials, exhibit quite good shrink performance, at the same time, the mechanical properties and optical properties of the CSF of the present invention are not compromised. Thus, the films of the present invention containing PCR resin are suitable for collation shrink film applications.

For example, in one preferred embodiment, the blend formulation of the present invention can be PCR2 resin having 70 wt % PCR resin loading (40/30/30 r-LDPE Natural 510A/r-HDPE Natural 921D/LDPE 150E); and the CSF film structure of the present invention made from the above blend formulation exhibits good shrink performance without compromising the film structure's mechanical properties, optical properties and processability properties.

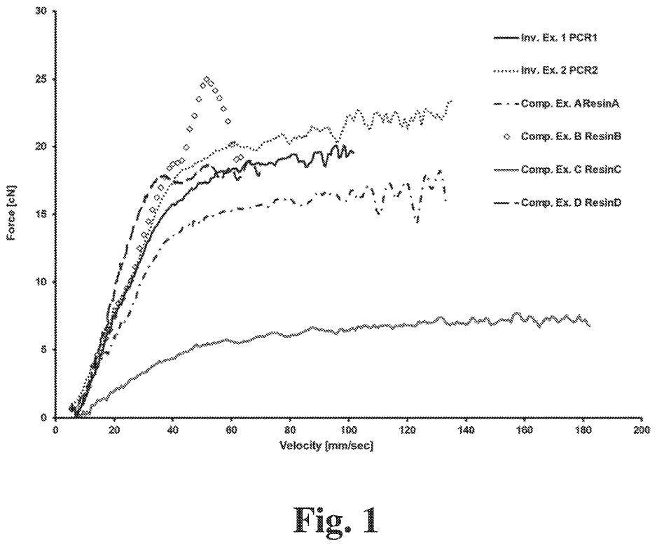

In FIG. 1, there is shown the superior melt strength of the resin samples of the Inventive Examples compared to the melt strength of the resin samples of the Comparative Examples. For instance, both the PCR1 resin of Inv. Ex. 1 and the PCR2 resin of Inv Ex. 2, each surprisingly show an excellent combination of high melt strength and good drawability than any of the resin's constituent components by themselves. Drawability is the maximum velocity at which a polymer strand breaks up during the melt strength test. High melt strength in combination with high drawability are desired to ensure good processability and good bubble stability in a blown film fabrication process. The PCR1 resin of Inv. Ex. 1 and the PCR2 resin of Inv Ex. 2, each have a higher melt strength than the ResinA of Comp Ex. A, the ResinC of Comp. Ex. C, and the ResinD of Comp. Ex. D. Also, the PCR1 resin of Inv. Ex. 1 and the PCR2 resin of Inv Ex. 2 each have significantly improved drawability than the ResinB of Comp. Ex. B and the ResinD of Comp. Ex. D.

### Other Embodiments

In one embodiment, the post-consumer recycled resin loading in the core layer of the multilayer film structure of the present invention is from greater than or equal to 70 percent to 90 percent.

In some embodiments, the post-consumer recycled resin loading in the overall film structure of the present invention, when the overall film structure is a monolayer (i.e., no skin layers present), is from greater than or equal to 30 percent to 90 percent in one embodiment; and from greater than or equal to 30 percent to 80 percent in another embodiment.

In some embodiments, the post-consumer recycled resin loading in the overall film structure of the present invention, when the overall film structure is a multilayer (e.g., a 3-layer or a 5-layer film structure), is from greater than or equal to 30 percent to 60 percent in one embodiment; and from greater than or equal to 30 percent to 50 percent in another embodiment.

In still another embodiment, the formulated resin of the present invention further comprises from 0.1 weight percent to 10 weight percent of one or more additives.

In yet another embodiment, the additive added to the formulated resin of the present invention comprises one or more additives selected from the group consisting of antioxidants, pigments, colorants, UV stabilizers, UV absorbers, processing aids, fillers, slip agents, anti-blocking agents, compatibilizers and the like; and mixtures thereof.

What is claimed is:

1. A blend resin composition for forming a shrink film therefrom comprising:
(a) at least one post-consumer recycled resin sourced from recycled high density polyethylene resin having a density of from 0.940 g/cc to 0.970 g/cc, and a melt index, I₂, of from 0.01 g/10 min to 1.0 g/10 min;
(b) at least one post-consumer recycled resin sourced from recycled low density polyethylene resin having a density of from 0.915 g/cc to 0.935 g/cc, and a melt index, I₂, of from 0.1 g/10 min to 2.0 g/10 min; and
(c) at least one virgin low density polyethylene resin having a density of from 0.915 g/cc to 0.925 g/cc and a melt index, I₂, of from 0.1 g/10 min to 1 g/10 min;
wherein the post-consumer recycled resin loading of the formulated resin is from greater than or equal to 30 percent to 90 percent.

2. The composition of claim 1, wherein the concentration of the at least one post-consumer recycled resin of the formulated resin, component (a), is from 20 weight percent to 50 weight percent; wherein the concentration of the at least one post-consumer recycled resin of the formulated resin, component (b) is from 20 weight percent to 70 weight percent; and wherein the concentration of the at least one virgin low density polyethylene resin of the formulated resin, component (c), is from 10 weight percent to 40 weight percent.

3. A pellet article for fabricating a shrink film therefrom comprising a blend composition comprising:
(a) at least one post-consumer recycled resin sourced from recycled high density polyethylene resin having a density of from 0.940 g/cc to 0.970 g/cc, and a melt index, I₂, of from 0.01 g/10 min to 1.0 g/10 min;
(b) at least one post-consumer recycled resin sourced from recycled low density polyethylene resin having a density of from 0.915 g/cc to 0.935 g/cc, and a melt index, I₂, of from 0.1 g/10 min to 2.0 g/10 min; and
(c) at least one virgin low density polyethylene resin having a density of from 0.915 g/cc to 0.925 g/cc and a melt index, I₂, of from 0.1 g/10 min to 1 g/10 min; wherein the PCR loading of the formulated resin is from greater than or equal to 30 percent to 90 percent.

4. The pellet article of claim 3, wherein the concentration of the at least one post-consumer recycled resin of the formulated resin, component (a), is from 20 weight percent to 50 weight percent; wherein the concentration of the at least one post-consumer recycled resin of the formulated resin, component (b) is from 20 weight percent to 70 weight percent; and wherein the concentration of the at least one virgin low density polyethylene resin of the formulated resin, component (c), is from 10 weight percent to 40 weight percent.

5. The pellet article of claim 3, wherein:
(i) the melt strength of the pellet is greater than or equal to 15 cN; and
(ii) the defect count number of a film based on the pellet is such that the defect has an equivalent circular diameter in the range of from 200 microns to 400 microns (per 24.6 cubic centimeters of film) of less than or equal to 20,000; and the defect has an equivalent circular diameter in the range of from 400 microns to 800 microns (per 24.6 cubic centimeters of film) of less than or equal to 1,000.

6. A shrink film comprising:
at least one monolayer or multi-layer film having at least one layer comprising a formulated resin, wherein the formulated resin comprises:
(a) at least one post-consumer recycled resin sourced from recycled high density polyethylene resin having a density of from 0.940 g/cc to 0.970 g/cc, and a melt index, I₂, of from 0.01 g/10 min to 1.0 g/10 min;
(b) at least one post-consumer recycled resin sourced from recycled low density polyethylene resin having a density of from 0.915 g/cc to 0.935 g/cc, and a melt index, I₂, of from 0.1 g/10 min to 2.0 g/10 min; and
(c) at least one virgin low density polyethylene resin having a density of from 0.915 g/cc to 0.925 g/cc and a melt index, I₂, of from 0.1 g/10 min to 1 g/10 min; wherein the post-consumer recycled resin loading of the formulated resin is from greater than or equal to 30 percent to 90 percent while maintaining the original properties of the shrink film at the same level or an increased level compared to a shrink film made from a formulated resin without the components (a) and (b).

7. The film of claim 6, wherein the concentration of the at least one post-consumer recycled resin of the formulated resin, component (a), is from 20 weight percent to 50 weight percent; wherein the concentration of the at least one post-consumer recycled resin of the formulated resin, component (b) is from 20 weight percent to 70 weight percent; and wherein the concentration of the at least one virgin low density polyethylene resin of the formulated resin, component (c), is from 10 weight percent to 40 weight percent.

8. The film of claim 6, wherein the thickness of the film is from 40 microns to 100 microns.

9. The film of claim 6, wherein the components (a), (b) and (c) of the formulated resin are first melt blended and then the resulting melt blend composition is formed into a plurality of pellets.

10. The film of claim 6, wherein the post-consumer recycled resin of component (a) is sourced from blow-molded plastic bottles.

11. The film of claim 6, wherein the post-consumer recycled resin of component (b) is sourced from flexible films.

12. The film of claim 6, wherein the film is a multilayer collation shrink film having a core layer comprising the formulated resin.

13. The film of claim 6, wherein the film exhibits one or more of the following properties:
(i) a haze of less than or equal to 50 percent when measured according to ASTM D1003;
(ii) a puncture resistance of greater than or equal to 3.3 MPa when measured according to ASTM D5748;
(iii) a dart drop impact resistance of greater than or equal to 70 grams when measured according to ASTM D1709 Type A;
(iv) an Elmendorf tear strength of greater than or equal to 100 grams-force in the machine direction when measured according to ASTM D1922 Type B (Constant radius);
(v) a secant modulus 2% of greater than or equal to 275 MPa in the machine direction and greater than or equal to 340 MPa in the cross direction when measured according to ASTM D882;
(vi) a shrink force in the machine direction of greater than or equal to 100 mN when measured according to ISO 14616;
(vii) a Contraction Force in the machine direction of greater than or equal to 2,600 mN when measured according to ISO 14616; and
(viii) a Free Shrinkage greater than or equal to 65 percent in the machine direction when measured according to the described fixed condition method with a temperature setpoint of 200° C. and a dwell time of 50 seconds.

14. The film of claim 6, wherein the formulated resin is in the form of one or more pellet articles.

15. A process of manufacturing the shrink film of claim 4, the process comprising the steps of:
(I) melt-blending the at least one post-consumer recycled resin, component (a), the at least one post-consumer recycled resin, component (b), the at least one virgin low density polyethylene resin, component (c), and any optional additives, thereby making the formulated resin; and
(II) forming at least one monolayer or multi-layer film using blown film extrusion, wherein at least one layer of the extruded film comprises the formulated resin.

16. A process of shrink packaging one or more items or articles comprising the steps of:
(A) wrapping the one or more items or articles in a heat-shrinkable, collation shrink film of claim 1 to form a shrink wrap package; and
(B) heating the shrink wrap package of step (i) by exposing the wrapped package to sufficient heat to cause shrinkage of the film which the film grips the one or more wrapped items by shrinkage and to cause intimate contact between the film and the one or more items or articles.

17. A packaged article packaged using a shrink film comprising the shrink film of claim 6.

18. A collation pack comprising one or more articles and a film bundling the one or more articles, said film having been heat shrunk into position by the process according to claim 16.
